(19) United States
(12) Patent Application Publication
(10) Pub. No.: US 2026/0080448 A1
(43) Pub. Date: Mar. 19, 2026

(54) METHOD FOR DETERMINING THE DIMENSIONS AND CONFIGURATION OF A VEHICLE WRAP SURFACE

(71) Applicant: IDMYFLEET LLC, Copiague, NY (US)

(72) Inventors: Christopher DEFEO, West Islip, NY (US); Paul HINTON, Salem, VA (US)

(21) Appl. No.: 19/402,479

(22) Filed: Nov. 26, 2025

Related U.S. Application Data
(63) Continuation of application No. PCT/US2024/052639, filed on Oct. 23, 2024.
(60) Provisional application No. 63/593,647, filed on Oct. 27, 2023.

(51) Int. Cl. G06Q 30/0601; G06Q 20/10; G06V 30/14

(52) U.S. Cl. CPC G06Q 30/0611; G06Q 20/102; G06V 30/14

(57) ABSTRACT

A method for determining the dimensions and configuration of a vehicle wrap surface. The customer selects a vehicle to be the subject of a vehicle wrap cost quotation from a vehicle wrap provider. A photograph of the subject vehicle's Vehicle Identification Number (VIN) is transmitted to the vehicle wrap provider that is remote from the vehicle. Optical character recognition (OCR) is performed on the photograph to convert the VIN directly to an electronic form. A VIN database is queried with the converted VIN to obtain the vehicle year, vehicle make and vehicle model. The dimensions and configuration of the vehicle wrap surface are derived from the obtained vehicle year, vehicle make and vehicle model. The provider determines the costs for printing a vehicle wrap forwards a cost quotation to the customer.

### C ROSS-REFERENCE TO RELATED APPLICATIONS

This Application claims benefit under Section 119 to International Application PCT/US2024/052639 entitled Method for Determining the Dimensions and Configuration of a Vehicle Wrap Surface, filed Oct. 23, 2024, which claims the benefit under 35 U.S.C. §119(e) from U.S. Provisional Patent Application No. 63/593,647 entitled Method and System for Managing Motor Vehicle Brand Wraps, filed Oct. 27, 2023.

### BACKGROUND OF THE INVENTION

### 1. Field of the Invention

The invention relates to a method for determining the dimensions and configuration of a vehicle wrap surface.

### 2. the Prior Art

Many home service providers, like plumbers and electricians, opt to advertise their business by applying decorative wraps to their fleet vehicles. These custom branded wraps provide high visibility advertising to potential customers in the neighborhood. A problem exists in capturing vehicle information for quoting, printing, installing and managing brand wraps for fleet vehicles or remotely located vehicles. Some attempts have been made to digitize imaging and track vehicles used for advertising purposes.

U.S. Published Patent Application 2020/0043246 entitled Systems and Methods for Generating Vehicle Wraps is a marketing system for gathering content from a company's webpage and soliciting the company for brand wrap business. They determine a vehicle type from an industry classification code, from an image of the vehicle captured from the potential customer's web content. Based on the captured web-based content, the system automatically generates mass marketing campaigns to entice companies to inquire about an automotive wrap. There is no indication that the vehicle is uniquely identified since the reference does not mention VINs and unique identification is not required for advertising. As can be appreciated, the accuracy of a vehicle brand wrap quotation requires positive identification of the fleet vehicles based on VIN numbers.

U.S. Published Patent Application 2005/0228689 entitled System and Method for Fabricating Informational Placard discloses a method for printing a temporary license plate placard. To capture vehicle information the VIN number is keyed into the system or electronically entered via a barcode scanner. This automated method of entering a barcode may be useful at a car dealership or DMV office. However, it is impractical for a fleet manager seeking a brand wrap quote since it requires direct access to the vehicle bearing the barcode and possession of a scanning system.

U.S. Published Patent Application 2009/0008955 entitled System and Method for Automatically Designing an Automobile Wrap discloses means for modifying an image to fit a vehicle's particular contours. The system takes a digital image of the vehicle panel and flattens the image to provide a distorted 2D vehicle image. The decorative wrap image is then stretched to match the 2D vehicle image. The flattening process is based on hand measurements of the vehicle panel. While hand measurements of a vehicle panel may be practical for a consumer to obtain one decorative wrap, it is impractical for commercial wrappers on a fleet of vehicles or where some of the vehicles are in a remote location. It is particularly challenging to accurately quote a vehicle and detrimental to the graphic designers if the template sizing is not exact.

U.S. Published Patent Application 2009/0299857 entitled System and Method for Obtaining Revenue through the Display of Hyper-Relevant Advertising on Moving Objects discloses a display 760 mounted on a vehicle for displaying different advertising based on demographic information. The system derives the physical characteristics of the vehicle from its VIN (Vehicle Identification Number). While the system stores and tracks vehicles using their VIN for marketing purposes, there is no suggestion to use this data for fleet owners desiring static brand wrap advertising.

Accordingly, it would be desirable to automate the process for capturing vehicle information from a multiplicity of remotely located vehicles, uniquely identifying the vehicle(s) and managing that information from brand wrap cost quotation through to installation.

### SUMMARY OF THE INVENTION

It is therefore an object of the present invention to provide a streamlined method for generating a vehicle wrap quotation.

It is another object to permit a vehicle owner to easily transmit VIN numbers to the vehicle wrap provider.

It is a further object to allow the vehicle owner to transmit the VIN number with a mobile electronic device, for example, a tablet or cellular telephone.

It is another object to allow the vehicle owner to take a photograph of the VIN number and transmit it to the vehicle wrap provider.

It is a further object to provide the vehicle wrap provider with tools and procedures for uniquely identifying vehicles from a received photograph of the vehicle's VIN number.

These and other related objects are achieved according to an embodiment of the invention by a method for determining the dimensions and configuration of a vehicle wrap surface. Initially, a customer's vehicle is selected to be the subject of a vehicle wrap cost quotation from a vehicle wrap provider. The customer transmits a photograph of the subject vehicle's Vehicle Identification Number (VIN) to the vehicle wrap provider that is remote from the vehicle. Optical character recognition (OCR) is performed on the photograph to convert the VIN directly to an electronic form. A VIN database is queried with the converted VIN to obtain vehicle data comprising a vehicle year, a vehicle make and a vehicle model. The dimensions of the vehicle wrap surface are calculated and the configuration, that is the contours, of the vehicle wrap surface is derived from the obtained vehicle data comprising the vehicle year, the vehicle make and the vehicle model. The costs are determined for (i) printing a vehicle wrap in a size that matches the calculated dimensions (ii) fitting the graphics to the derived vehicle configuration and (iii) installing the vehicle wrap on the vehicle wrap surface. A vehicle wrap cost quotation is generated from the determined costs and transmitting the vehicle cost quotation to the customer.

The customer's vehicle is a fleet vehicle or one of a plurality of fleet vehicles.

The transmitting step includes taking a picture with a mobile tablet or cellular phone. The photograph is transmitted in a jpg, jpeg, heic, heif, png, gif, WebP, tiff, bmp, svg format as well as other standard image file types. The performing step includes VIN OCR endpoint extracting the VIN number text from the image. The querying step includes querying a product information catalog vehicle listing with API. The fitting step includes processing a 2D image to fit a non-linear, curved, discontinuous automobile surface which comprises the configuration of the wrap surface.

Following the generating step, the method further includes sending an automated estimate based on the determined vehicle type. Following the generating step, the method further includes communicating a quote acceptance from the client to the wrap provider. Following the communicating step, the method further includes receiving a customer payment. Following the receiving step, the method further includes installing the wrap on the wrap surface.

In a further embodiment the method additionally includes determining if the obtained vehicle data comprising the vehicle year, the vehicle make and the vehicle model include more than one configuration for the vehicle wrap surface. If more than one configuration is possible, then an intermediate defined logic processing step is initiated to confirm the configuration for the vehicle wrap surface. The defined logic processing step includes logically processing one or more defined vehicle parameters until the confidence level of the configuration selection exceeds a preset confidence level. The defined logic processing step further includes defining one or more vehicle parameters which are unique from each other. Then logically selecting one vehicle parameter and comparing the selected one vehicle parameter to a vehicle database. Followed by assessing whether the comparison yields a configuration that exceeds the preset confidence level.

In another embodiment, the defined logic processing step includes defining one or more vehicle parameters which are unique from each other. Then logically selecting the order in which vehicle parameters are compared to a vehicle database. Followed by assessing after each comparison whether the comparisons yield a configuration that exceeds the preset confidence level.

The defined vehicle parameters are selected from manufacturing data, vehicle specifications and vehicle options. The preset confidence level comprises yielding a unique configuration based on the vehicle data comprising the vehicle year, the vehicle make and the vehicle model in combination with favorably compared vehicle parameters.

The transmitting step includes transmitting a photograph of the subject's VIN via one of SMS text messaging, web portal, personal computer, mobile electronic telecommunications device, the world wide web, or other networked connection. The photograph includes an image of the VIN number on one of the subject vehicles, an insurance card for the subject vehicle, a registration document for the subject vehicle, a title document for the subject vehicle, other electronic or paper document for the subject vehicle. For fleets with multiple vehicles, the photograph includes an image of the VIN number on all subject vehicles, an insurance card for all subject vehicles, a registration document for all subject vehicles, a title document for all subject vehicles, other electronic or paper document for all subject vehicles.

### BRIEF DESCRIPTION OF THE DRAWINGS

The advantages, nature, and various additional features of the invention will appear more fully upon consideration of the illustrative embodiments now to be described in detail in connection with accompanying drawings. In the drawings wherein like reference numerals denote similar components throughout the views:

FIG. 1 is a flowchart providing the steps according to a first embodiment of the inventive method.

FIG. 2 is a flowchart providing the steps according to a second embodiment of the inventive method.

FIG. 3 is a flowchart providing the steps according to a third embodiment of the inventive method.

### DETAILED DESCRIPTION OF THE PREFERRED EMBODIMENTS

A problem exists in capturing vehicle information for quoting, printing, installing and managing brand wraps for fleet vehicles or remotely located vehicles. Some attempts have been made to digitize imaging and track vehicles used for advertising purposes. However, these previous methods require specialized hardware, software, processing systems and corresponding training for effective use. The method proposed herein, provides a simplified method to convey a Vehicle Identification Number (VIN) to a brand wrap provider for the purpose of obtaining a price quotation. As can be appreciated, the provider needs the dimensions and configuration of a vehicle wrap surface in order to prepare an accurate price quotation.

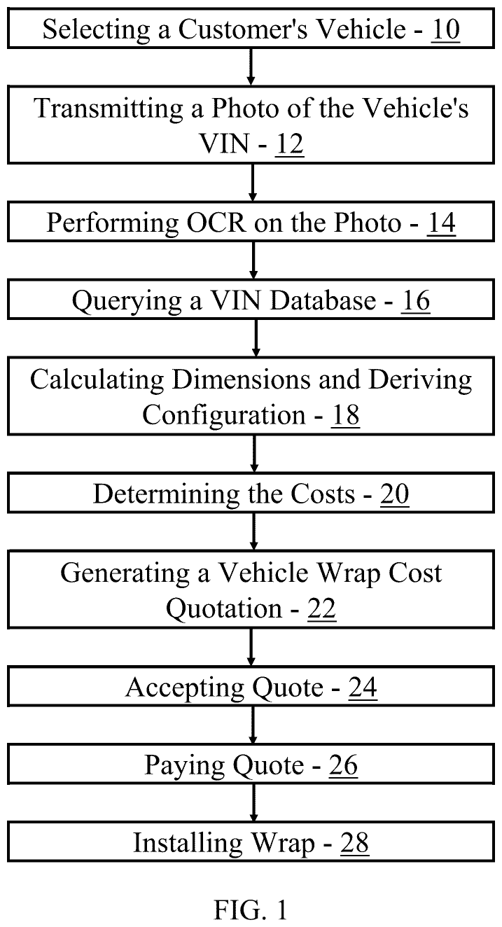

In one embodiment of the invention, and with reference to FIG. 1, there are presented a series of steps relating to a method for determining the dimensions and configuration of a vehicle wrap surface. A customer vehicle is selected in step 10 which will be the subject of a vehicle wrap cost quotation from a vehicle wrap provider or installer.

A photograph of the subject vehicle's Vehicle Identification Number (VIN) is transmitted to the vehicle wrap provider that is remote from the vehicle in step 12. The invention is particularly suited to providing cost quotations for a fleet of vehicles. In many instances the vehicles of the fleet are stationed at various locations. Those locations could be in different cities or different states. As a result, no one person at the customer's business has direct access to all of the vehicles within the fleet at one time. The method therefore empowers any employee to take a photograph of a readily accessible vehicle with a mobile device such as a tablet or cellular telephone. For example, the employee locates the VIN on the lower driver's side windshield and takes a picture of the VIN though the windshield. Alternatively, the employee may locate the VIN on the pillar accessible by opening the driver's door. The vehicle based VIN sources may also include a bar code of the VIN. The provider can scan the bar code, if included in the photograph, to confirm the OCR converted VIN. Depending on the type of mobile device and its settings, the photograph can be in any standard format, for example, jpeg, heif, png, gif, WebP, tiff, bmp or svg format.

The transmitting step includes transmitting a photograph of the subject's VIN via one of SMS text messaging, web portal, personal computer, mobile electronic telecommunications device, the world wide web or other networked connection. The photograph includes an image of the VIN number on one of the subject vehicles, an insurance card for the subject vehicle, a registration document for the subject vehicle, a title document for the subject vehicle, other electronic or paper document for the subject vehicle.

The inventive transmitting step therefore provides flexibility in selecting the source of the VIN number and a wide range of options for capturing and forwarding it to the wrap provider. Fleet owners can use different permutations of VIN number sources and capture methods. The fleet vehicles may be stationed at many different locations while their registration data may be kept at the head office. In addition, the type of electronic equipment that is available to a customer's employee may vary from location to location. Accordingly, the flexibility inherent in the transmitting step allows remote scalability where any employee, in any location and capture and transmits VINs. Thus, the cost and time burden on the customer is reduced by the ability to administratively delegate or geographically distribute the VIN capture step, for example, on a state-by-state basis, a location-by-location basis or even a vehicle-by-vehicle basis. The OCR processing of the VIN by the wrap provider is a new technical advantage then ensures accurate capture, transmission and entry of the VIN number text compared to the error prone manual VIN entry.

The provider performs optical character recognition (OCR) on the photograph to convert the VIN directly to an electronic form in step 14. The performing step includes VIN OCR endpoint extracting the VIN number text from the image.

Prior to the OCR process, or as part of the OCR process, the photograph may be converted to a preferred format. For example, if the OCR processor is embedded with Adobe Acrobat, the photograph may be converted to a pdf for OCR processing. For other software the photograph is converted to jpeg for OCR processing.

Next, the provider queries a VIN database with the converted VIN to obtain vehicle date including at least the vehicle year, vehicle make and vehicle model in step 16. The querying step includes querying a product information catalog vehicle listing with API.

Once the vehicle is identified, the provider calculates the dimensions and derives the configuration of the vehicle wrap surface in step 18 from the obtained vehicle year, vehicle make and vehicle model.

The provider then determines the costs for (i) printing a vehicle wrap in a size that matches the calculated dimensions (ii) fitting the graphics to accommodate the derived vehicle configuration and (iii) installing the vehicle wrap on the vehicle wrap surface in step 20. The manipulating step includes processing a 2D image to fit a non-linear, curved, discontinuous wrap surface, that is the configuration of the wrap surface.

The provider generates a vehicle wrap cost quotation from the determined costs and transmitting the vehicle cost quotation to the customer in step 22. The cost quotation may include a mock-up of the wrap on the vehicle. The mock-up may be digitally enhanced or AI processed for greater accuracy and realism.

Following the quotation, the customer accepts the quote in step 24 and subsequently pays the invoice or quote in step 26. The provider or installer has the wrap printed and installed in step 28. The wrap is printed with a graphic image designed by the provider or others. The wrap often advertises the customer's services and provides a telephone or company website contact information along with logo and tagline. The wrap is printed on a wide format printer on a cast or calendared vinyl sheet, for example a vinyl film between about 1.1 mil and 4 mil thick. The wrap is printed in a size which matches the calculated dimensions. The wrap is applied to the contoured vehicle configuration with a compatible adhesive. The vinyl film may include an adhesive layer on its back surface protected by a carrier sheet.

A second embodiment of the invention will be described in detail below. In the earlier method the querying step 16 identified a vehicle, and the provider was able to proceed to calculating the dimensions and deriving the configuration in step 18. The querying step typically returns a vehicle year, vehicle make and vehicle model which clearly identifies one class or type of vehicle, where all vehicles within that class have the same dimensions and configuration. In other words, all vehicles having a year, make and model in common are the same vehicle class or type.

In the tolling/diagnostics applications of the prior art, identifying a vehicle by its VIN is totally sufficient. The VIN provides all needed data to identify and charge the owner for the toll. In such instances, the VIN is used as part of an administrative action. The invention recognizes a widespread problem within the vehicle wrap industry, namely, that a VIN does not necessarily identify all aspects of the vehicle's configuration. This problem is addressed by assessing the VIN to determine if it uniquely identifies a vehicle. That is, does the VIN number represent only one vehicle configuration. Failing to perform this step could easily result in a quote for a mistaken vehicle trim/package geometry. If the problem persists, the wraps could be printed incorrectly or the installer may have unexpected customization work to complete the project. If a fleet vehicle is only available for a one day wrap installation, such errors could result in a failure to complete the project, resulting in added costs to the customer and installer.

After addressing the unique VIN problem, the inventive method then employs confidence-based logic to drill down level by level until the vehicle's configuration is identified beyond a preset confidence level.

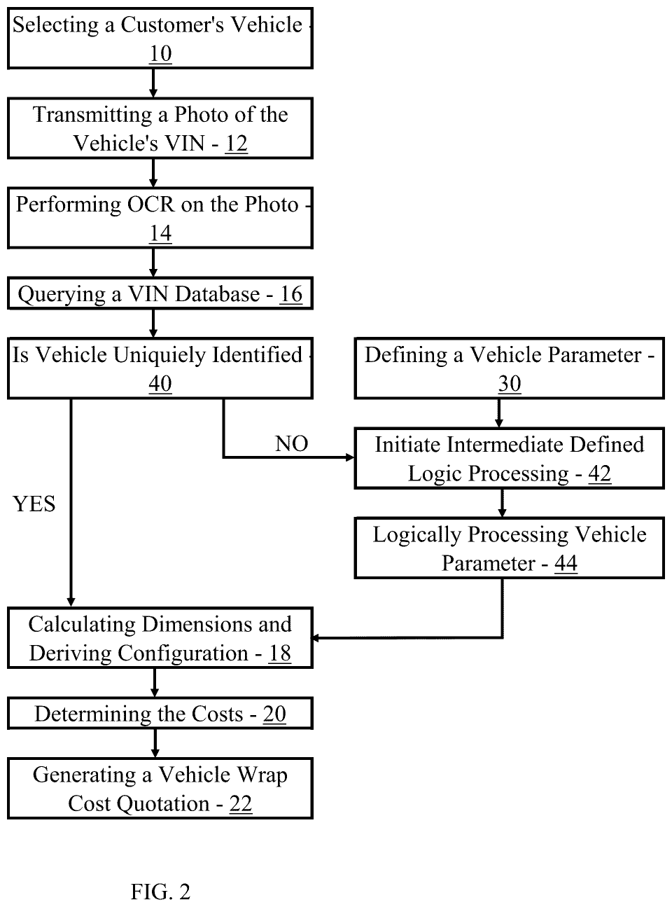

In certain instances, all vehicles having a year, make and model in common are not the same vehicle class or type. The second embodiment allows the provider to determine if more than one type of vehicle is present in the class and to perform additional steps to obtain a unique vehicle type as illustrated in FIG. 2. The method determines if the obtained vehicle year, vehicle make and vehicle model includes more than one configuration for the vehicle wrap surface, as shown in step 40. If the answer is “Yes” the method can continue with the provider calculating the dimensions and deriving the configuration in step 18, followed by steps 20 and 22.

If the answer is “No” the new sub-process begins by initiating an intermediate defined logic processing step to confirm the configuration for the vehicle wrap surface in step 42. Previously, vehicle parameters are defined in step 30. The defined vehicle parameters are selected from manufacturing data, vehicle specifications and vehicle options. Examples of special vehicle parameters would include a trim level, door layout, vehicle weight, overall height, storage space or vehicle options like a sunroof.

The defined logic processing step includes logically processing one or more defined vehicle parameters until the confidence level of the configuration selection exceeds a preset confidence level in step 44. In the simplest case, after logically processing the vehicle parameter, a unique vehicle is identified and the method can continue with the provider calculating the dimensions and deriving the configuration in step 18, followed by steps 20 and 22.

The defining step 30 may include defining one or more vehicle parameters which are unique from each other. Step 42 then includes logically selecting one vehicle parameter and comparing the selected one vehicle parameter to a vehicle database. Step 44 then includes assessing whether the comparison yields a configuration that exceeds the preset confidence level.

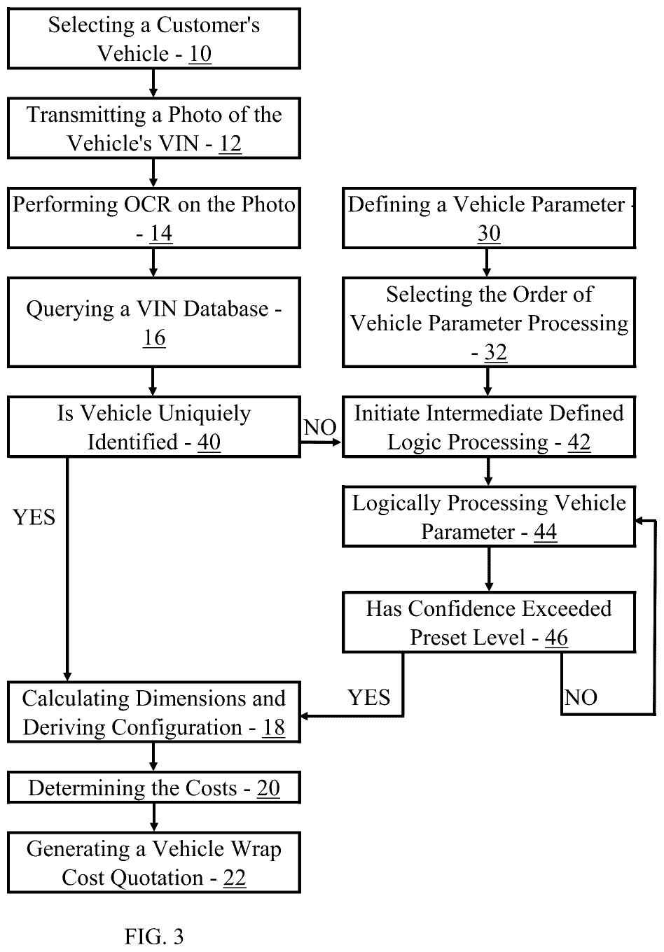

Alternatively, as illustrated in FIG. 3, the defining step 30 may include defining one or more vehicle parameters which are unique from each other. Step 32 then includes logically selecting the order in which vehicle parameters are compared to a vehicle database. After processing one vehicle parameter, step 46 then assesses after each comparison whether the comparisons yield a configuration that exceeds the preset confidence level. If “Yes” the method can continue with the provider calculating the dimensions and deriving the configuration in step 18, followed by steps 20 and 22. If “No” then the next parameter is logically processed by repeating step 44. Steps 44 and 46 can be reiteratively executed until a “Yes” response is obtained. The step of assessing a preset confidence level comprises yielding a unique configuration based on the vehicle year, vehicle make and vehicle model in combination with favorably compared vehicle parameters.

A key feature of the invention, is the customer's ability to take a photograph with their cellular telephone and forward it by text or email to the wrap provider. However, the customer may be provided with an app or website from the wrap provider to enhance the basic selecting, photographing and transmitting steps. This could be useful for fleet customers, where the selected vehicles are cataloged so the fleet customer can see which vehicles have already had their VINs transmitted. In a web-based system, the catalogue feature can be programmed to alert the customer if they are attempting to enter the same VIN twice. The cost quotation could then be itemized to relate back to the customer's catalog of vehicles. The wrap provider uses a system of existing or custom software to perform steps 14, 16, 18, 20 and 22. These steps of the present invention can be implemented by hardware components, software components or an embodiment including both hardware and software elements. In a preferred embodiment, the present invention is implemented in software, which includes but is not limited to firmware, resident software, microcode, etc.

In summary, accurately determining a vehicle's wrap surface configuration is a long-standing industry wide problem. Fleet graphics is a multi-billion-dollar industry, but quoting remains manual and error-prone. This invention modernizes quoting through automation, making wraps more accessible to businesses of all sizes. In other words, the goal is achieved by shifting the VIN to wrap surface configuration conversion problem from the customer and its employees to the inventive system operated by the wrap provider. The identification of VIN indefiniteness and the provided steps to implement vehicle configuration specificity is a novel approach to streamline wrap quotation and installation by securing accurate data at the outset of each project.

On the wrap provider side, the invention may comprise a computer program product accessible from a computer-usable or computer-readable medium providing program code for use by or in connection with a computer or any instruction execution system. For the purposes of this description, a computer-usable or computer readable medium can be any apparatus that may include, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk - read only memory (CD-ROM), compact disk - read/write (CD-R/W) and DVD.

Thus, the method may be practiced by wrap providers having a non-transitory computer readable medium including a program of instructions for determining the dimensions and configuration of a vehicle wrap surface that when executed by a computer performs steps 18, 20 and 22, along with the subroutine steps 30, 32, 40, 42, 44 and 46.

Having described preferred embodiments of self-assembling geometric networks (which are intended to be illustrative and not limiting), it is noted that modifications and variations can be made by persons skilled in the art in light of the above teachings. For example, two or more vehicle parameters may be pre-defined in the system. There may be different sets of parameters, for example, one set for vans and another set for box trucks. Parameters may be compared serially, in parallel or other combination to more efficiently achieve the present confidence lever, or identify a unique vehicle type. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for determining the dimensions and configuration of a vehicle wrap surface for generating a vehicle wrap quotation for the customer comprising the steps of:
selecting a customer's vehicle to be the subject of a vehicle wrap cost quotation from a vehicle wrap provider;
transmitting a photograph of the subject vehicle's Vehicle Identification Number (VIN) to the vehicle wrap provider that is remote from the vehicle;
performing optical character recognition (OCR) on the photograph to convert the VIN directly to an electronic form;
querying a VIN database with the converted VIN to obtain vehicle data comprising a vehicle year, a vehicle make and a vehicle model;
calculating the dimensions and deriving the configuration of the vehicle wrap surface from the obtained vehicle data comprising the vehicle year, the vehicle make and the vehicle model;
determining the costs for (i) printing a vehicle wrap in a size that matches the calculated dimensions (ii) fitting the graphics to the derived vehicle configuration and (iii) installing the vehicle wrap on the vehicle wrap surface; and
generating a vehicle wrap cost quotation from the determined costs and transmitting the vehicle wrap cost quotation to the customer.

2. The method according to claim 1, wherein the customer's vehicle is a fleet vehicle.

3. The method according to claim 1, wherein the transmitting step includes taking a picture with a mobile tablet or cellular phone.

4. The method according to claim 3, wherein the transmitting step includes transmitting a photograph in a format selected from the group consisting of jpeg, heif, png, gif, WebP, tiff, bmp or svg format.

5. The method according to claim 1, wherein the performing step includes VIN OCR endpoint extracting the VIN number text from the image.

6. The method according to claim 1, wherein the querying step includes querying a product information catalog vehicle listing with API.

7. The method according to claim 1, wherein the fitting step includes processing a 2D image to fit a non-linear, curved, discontinuous automobile surface which comprises the configuration of the wrap surface.

8. The method according to claim 1, wherein following the generating step, the method further includes the step of:
communicating a quote acceptance from the client to the wrap provider.

9. The method according to claim 8, wherein following the communicating step, the method further includes the step of:
receiving a customer payment.

10. The method according to claim 9, wherein following the receiving step, the method further includes the step of:
installing the wrap on the wrap surface.

11. A method for determining the dimensions and configuration of a vehicle wrap surface for generating a vehicle wrap quotation for the customer comprising the steps of:
selecting a customer's vehicle to be the subject of a vehicle wrap cost quotation from a vehicle wrap provider;
transmitting a photograph of the subject vehicle's Vehicle Identification Number (VIN) to the vehicle wrap provider that is remote from the vehicle;
performing optical character recognition (OCR) on the photograph to convert the VIN directly to an electronic form;
querying a VIN database with the converted VIN to obtain vehicle data comprising a vehicle year, a vehicle make and a vehicle model;
determining if the obtained vehicle data comprising the vehicle year, the vehicle make and the vehicle model includes more than one configuration for the vehicle wrap surface;
if the obtained vehicle data includes more than one configuration, initiating an intermediate defined logic processing step including logically processing one or more defined vehicle parameters until the confidence level of the configuration selection exceeds a preset confidence level to confirm the configuration for the vehicle wrap surface;
calculating the dimensions and deriving the configuration of the vehicle wrap surface from the confirmed configuration;
determining the costs for (i) printing a vehicle wrap in a size that matches the calculated dimensions (ii) fitting the graphics to the derived vehicle configuration and (iii) installing the vehicle wrap on the vehicle wrap surface; and
generating a vehicle wrap cost quotation from the determined costs and transmitting the vehicle wrap cost quotation to the customer.

12. The method of claim 11, wherein the defined logic processing step further includes:
defining one or more vehicle parameters which are unique from each other;
logically selecting one vehicle parameter and comparing the selected one vehicle parameter to a vehicle database; and
assessing whether the comparison yields a configuration that exceeds the preset confidence level.

13. The method of claim 11, wherein the defined logic processing step further includes:
defining one or more vehicle parameters which are unique from each other;
logically selecting the order in which vehicle parameters are compared to a vehicle database; and
assessing after each comparison whether the comparisons yield a configuration that exceeds the preset confidence level.

14. The method of claim 11, wherein the defined vehicle parameters are selected from manufacturing data, vehicle specifications and vehicle options.

15. The method of claim 11, wherein the preset confidence level comprises yielding a unique configuration based the vehicle data comprising the vehicle year, the vehicle make and the vehicle model in combination with favorably compared vehicle parameters.

16. The method of claim 1, wherein the transmitting step includes transmitting a photograph of the subject vehicle's VIN via one of SMS text messaging, web portal, personal computer, mobile electronic telecommunications device, the world wide web, or other networked connection.

17. The method of claim 16, wherein the photograph includes an image of the VIN number on one of the subject vehicles, an insurance card for one of the subject vehicles, a registration document for one of the subject vehicles, a title document for one of the subject vehicles, other electronic or paper document for one of the subject vehicles.
